(19) United States
(12) Patent Application Publication
(10) Pub. No.: US 2007/0185223 A1
(43) Pub. Date: Aug. 9, 2007

(54) Tin and transition metal free polyurethane foams

(75) Inventor: Marco Ortalda, Torino (IT)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/588,759

(22) PCT Filed: Feb. 18, 2005
(86) PCT No.: PCT/EP05/01674

§ 371 Date: Aug. 8, 2006

(51) Int. Cl. C08G 18/00

(52) U.S. Cl. 521/172

(57) ABSTRACT

The invention relates to tin-free polyurethane foams which are obtainable by reacting polyisocyanates (a) with compounds having isocyanate-reactive hydrogen atoms (b) in the presence of bismuth carboxylates as catalysts (c1).

The invention relates to tin-free polyurethane foams which are obtainable by reacting polyisocyanates (a) with compounds having isocyanate-reactive hydrogen atoms (b) in the presence of bismuth carboxylates as catalysts (c1).

Foams composed of polyurethane (PUR) have been known for a long time and have a number of technologically useful properties, e.g. energy-absorbing or thermally insulating properties combined with a low weight. The wide variety of uses include, inter alia, shoe soles, steering wheels or damping elements for the automobile industry. To achieve economical production of moldings, short demolding times combined with a satisfactory curing behavior have to be ensured. This is achieved by combinations of catalysts in the system. It can be seen from the prior art that mixtures of tertiary amines and organotin compounds are usually used for this purpose. Tertiary amines used as catalysts include, for example, triethylenediamine and bis(dimethylaminoethyl) ether. Examples of commercially available catalysts in which these compounds are present as active constituents are Lupragen N203® (BASF) and Niax A1® (Crompton). Mixtures of these amines are frequently used. An example of an organotin compound which is used is dibutyltin dilaurate (Niax® D22, Crompton).

The simultaneous use of amines and organotin compounds has a synergistic action in respect of the catalytic properties, so that the sole use of amine catalysts is not able to achieve satisfactory curing behavior for many applications. These include, for example, microcellular foams based on polyetherols which are used for producing shoe soles. Unsatisfactory curing behavior is reflected, inter alia, in long buckling times or unsatisfactory dimensional stability of the shoe soles after demolding. The buckling time is a method of estimating the demolding time of shoe soles employed in shoe sole production. The buckling time is the time for which a test specimen has to remain in the mold to prevent occurrence of surface cracks on subsequent bending of the test plate through 180°.

The public is taking an increasingly critical view of the use of organotin compounds in articles serving as clothing, including, for example, shoes, owing to the unclear toxicological situation. There is therefore a demand for systems which can be processed without tin catalysts and which at the same time have curing behavior which is at least comparable with conventional tin-catalyst systems.

The use of bismuth carboxylates for catalyzing PUR systems is known for compact coating systems.

Furthermore, DE-A-101 42 296 describes the preparation of polyurethane elastomers, in which tin-containing compounds are replaced as catalysts by titanium and zirconium compounds, optionally in combination with bismuth compounds.

However, for reasons similar to those indicated above, it is also sensible to provide polyurethane foams which contain no transition metals.

It was an object of the present invention to provide systems which can be used for producing polyurethane foams, in particular microcellular PUR moldings, which should without the use of tin catalysts and without use of catalysts comprising transition metals display a curing behavior which is at least comparable to the known systems and display other processing and use properties which are at least comparable and should at the same time have toxicological and economic advantages.

This object was able to be achieved by the use of bismuth carboxylates in specific amounts as tin substitutes.

The invention provides tin-free polyurethane foams, preferably tin-free integral polyurethane foams, particularly preferably tin-free flexible integral polyurethane foams, which have a density of from 100 to 800 g/l and are obtainable by reacting
a) polyisocyanates with
b) compounds having isocyanate-reactive hydrogen atoms in the presence of
c1) bismuth carboxylates as catalysts, with the bismuth carboxylates being used in an amount of from 0.2 to 2% by weight, preferably from 0.4 to 1.5% by weight, particularly preferably from 0.5 to 1% by weight, based on the total weight of the component b).

The invention further provides a process for producing tin-free polyurethane foams which have a density of from 100 to 800 g/l and are obtainable by reacting
a) polyisocyanates with
b) compounds having isocyanate-reactive hydrogen atoms in the presence of
c1) bismuth carboxylates as catalysts, with the bismuth carboxylates being used in an amount of from 0.2 to 2% by weight, preferably from 0.4 to 1.5% by weight, particularly preferably from 0.5 to 1% by weight, based on the total weight of the component b).

Finally, the invention provides for the use of bismuth carboxylates as substitutes for tin-containing catalysts in the production of polyurethanes, in particular polyurethane foams having a density of from 100 to 800 g/l.

For the purposes of the present invention, tin-free polyurethanes are polyurethanes which are produced without addition of tin-containing compounds such as the known tin-containing catalysts. However, it cannot be ruled out that tin may be detectable in the polyurethanes of the invention when using sufficiently precise analytical methods, since this can get into the polyurethane foam as impurity in the customary starting materials.

The polyurethanes of the invention have a density of from 100 to 800 g/l, preferably from 150 to 700 g/l, particularly preferably from 200 to 600 g/l.

In a preferred embodiment, the polyurethanes of the invention are integral foams in accordance with DIN 7726. The integral polyurethane foams of the invention are generally integral foams in accordance with DIN 7726. In a preferred embodiment, the invention provides integral foams based on polyurethanes having a Shore hardness in the range 20-90 A, preferably from 50 to 80 Shore A, measured in accordance with DIN 53505. Furthermore, the integral foams of the invention preferably have a tensile strength of from 2 to 20 N/mm², preferably from 6 to 18 N/mm², measured in accordance with DIN 53 504. In addition, the integral foams of the invention preferably have an elongation of from 100 to 800%, preferably from 220 to 700%, measured in accordance with DIN 53504. Finally, the integral foams of the invention preferably have a tear propagation resistance of from 2 to 45 N/mm, preferably from 8 to 38 N/mm, measured in accordance with DIN 53507.

In particular, the polyurethanes of the invention are elastomeric, flexible integral polyurethane foams.

The polyisocyanates (a) used for producing the polyurethane foams of the invention include the aliphatic, cycloaliphatic and aromatic isocyanates known from the prior art and also any mixtures thereof. Examples are diphenylmethane 4,4′-diisocyanates, the mixtures of monomeric diphenylmethane diisocyanates and homologues of diphenylmethane diisocyanate having a larger number of rings (polymeric MDI), tetramethylene diisocyanate, hexamethylene diisocyanate (HDI), tolylene diisocyanate TDI) and mixtures thereof.

Preference is given to using 4,4′-MDI and/or HDI. The particularly preferred 4,4′-MDI can contain small amounts, up to about 10% by weight, of allophanate- or uretonimine-modified polyisocyanates. Small amounts of polyphenylenepolymethylene polyisocyanates (crude MDI) can also be used. The total amount of these high-functionality polyisocyanates should not exceed 5% by weight of the isocyanate used.

The polyisocyanates (a) can also be used in the form of polyisocyanate prepolymers. These prepolymers are known in the prior art. They are prepared in a manner known per se by reacting the above-described polyisocyanates (a), for example at temperatures of about 80° C., with compounds (b) which have isocyanate-reactive hydrogen atoms and are described below to form the prepolymer. The polyol/polyisocyanate ratio is generally selected so that the NCO content of the prepolymer is from 8 to 25% by weight, preferably from 10 to 22% by weight, particularly preferably from 13 to 20% by weight.

As compounds having isocyanate-reactive hydrogen atoms (b), it is possible to use compounds which bear two or more reactive groups selected from among OH groups, SH groups, NH groups, NH₂ groups and CH-acid groups such as β-diketo groups in the molecule. Depending on the choice of the component (b), the term polyurethanes as used for the purposes of the present invention encompasses polyisocyanate polyaddition products in general, for example also polyureas.

In general, compounds used as component (b) have a functionality of from 1.8 to 8, preferably from 2 to 6, and a molecular weight of from 300 to 8000, preferably from 400 to 6000. Compounds which have been found to be useful are, for example, polyether polyamines and/or polyols selected from the group consisting of polyether polyols, polyester polyols, polythioether polyols, polyesteramides, hydroxyl-containing polyacetals and hydroxyl-containing aliphatic polycarbonates and mixtures of at least two of the polyols mentioned.

Preference is given to using polyester polyols and/or polyether polyols. Particular preference is given to using polyether polyols, in particular polyether polyols which have at least 10% primary hydroxyl groups. The hydroxyl number of the polyhydroxyl compounds is generally from 5 to 1000, preferably from 15 to 200. Furthermore, the compounds (b) can be used in admixture with customary chain extenders and/or crosslinkers such as ethylene glycol, butanediol, or diethylene glycol.

It is also possible to use polyetherols having a low unsaturated content as polyetherols (b). For the purposes of the present invention, polyols having a low unsaturated content are, in particular, polyether alcohols having a content of unsaturated compounds of less than 0.02 meq/g, preferably less than 0.01 meq/g. Such polyether alcohols are usually prepared by addition of alkylene oxides, in particular ethylene oxide, propylene oxide and mixtures thereof, onto at least bifunctional alcohols in the presence of double metal cyanide catalysts.

Furthermore, it has been found in the context of the present invention that the component (c1) can be used very advantageously when polymer polyols having a content of thermoplastic polymers of from 2 to 50% by weight, preferably from 10 to 45% by weight, are used as component (b). These are polymer polyols which are customary in the field of polyurethanes and are frequently also referred to as graft polyols. These polymer polyols are generally known and commercially available and are usually prepared by free-radical polymerization of suitable olefinic monomers, for example styrene, acrylonitrile, acrylates and/or acrylamide, in a polyetherol serving as graft base. The side chains are generally formed by transfer of the free radicals of growing polymer chains onto polyetherols. The polymer polyol comprises, apart from the graft copolymers, predominantly the homopolymers of the olefins dispersed in unchanged polyetherol.

In a preferred embodiment, acrylonitrile, styrene, in particular styrene and acrylonitrile in a ratio of from 1:1 to 3:1, are used as monomers and the grafting reaction is carried out in a polyetherol or polyesterol as continuous phase, if appropriate in the presence of further monomers, a macromer, a moderator and using a free-radical initiator, usually an azo or peroxide compound.

Possible substrate polyetherols are the polyetherols described above.

Macromers, also referred to as stabilizers, are linear or branched polyols which have number average molecular weights up to 2000 g/mol and contain at least one terminal, reactive olefinically unsaturated group. The ethylenically unsaturated group can be inserted into an existing polyol by reaction with anhydrides (maleic anhydride, fumaric acid), acrylate and methacrylate derivatives and also isocyanate derivatives such as 3-isopropenyl-1,1-dimethylbenzyl isocyanates and isocyanatoethyl methacrylates.

During the free-radical polymerization, the macromers are built into the copolymer chain. This forms block copolymers which have a polyether block and a polyacrylonitrile-styrene block and act as phase compatibilizers at the interface of the continuous phase and the disperse phase and suppress agglomeration of the polymer polyol particles. The proportion of macromers is usually from 1 to 15% by weight, based on the total weight of the monomers used for preparing the polymer polyols.

In a preferred embodiment, use is made of from 2 to 50% by weight, preferably from 5 to 40% by weight, more preferably from 7 to 30% by weight and particularly preferably from 10 to 25% by weight, of polymer polyols, based on 100% by weight of the components (b).

The reaction of the components a) and b) is usually effected in the presence of blowing agents (d). As blowing agents (d), it is possible to use known chemically or physically acting compounds. As chemically acting blowing agent, preference is given to using water. Examples of physical blowing agents are inert (cyclo)aliphatic hydrocarbons which have from 4 to 8 carbon atoms and vaporize under the conditions of polyurethane formation. The amount of blowing agents used depends on the desired density of the foams.

The reaction of components a) and b) can, if appropriate, be carried out in the presence of (e) auxiliaries and/or additives such as cell regulators, mold release agents, pigments, reinforcing materials such as glass fibers, surface-active compounds and/or stabilizers against oxidative, thermal, hydrolytic or microbial degradation or aging.

As catalysts (component c), use is made of bismuth carboxylate (component c1)in the polyurethane foams of the invention. In the bismuth carboxylate (c1), bismuth is preferably present in the oxidation stages 2 or 3, in particular 3. As carboxylic acids for salt formation, preference is given to using carboxylic acids having from 6 to 14 carbon atoms, particularly preferably from 8 to 12 carbon atoms. Examples of particularly useful bismuth salts are bismuth(III) neodecanoate, bismuth 2-ethylhexanoate and bismuth octanoate.

In a preferred embodiment, the component (c1) is dissolved in a carboxylic acid before addition to the reaction of the components (a) and (b) and is added in dissolved form to the reaction. As solvents, preference is given to using carboxylic acids having from 6 to 14 carbon atoms, particularly preferably from 8 to 12 carbon atoms. Examples are octanoic acid and neodecanoic acid. The solvent used is preferably the same acid which also forms the carboxylate radical in the component (c1).

In a preferred embodiment, the reaction of the components a) and b) occurs only in the presence of the bismuth carboxylates (c1) as organic metal catalysts, i.e. no further organic metal catalysts are added to the reaction.

In a preferred embodiment, the reaction of the components a) and b) is carried out not only in the presence of bismuth carboxylates (c1) as catalysts but additionally in the presence of organic amines (component c2).

As organic amines, it is possible to use the tertiary amines known from the prior art. Preference is given to using tertiary amines.

Possible amines are, for example, organic amines such as triethylamine, triethylene-diamine, tributylamine, dimethylbenzylamine, N,N,N′,N′-tetramethylethylenediamine, N,N,N′,N′-tetramethylbutanediamine, N,N,N′,N′-tetramethylhexane-1 ,6-diamine, dimethylcyclohexylamine, pentamethyldipropylenetriamine, pentamethyidiethylene-triamine, 3-methyl-6-dimethylamino-3-azapentol, dimethylaminopropylamine, 1,3-bisdimethylaminobutane, bis(2-dimethylaminoethyl) ether, N-ethylmorpholine, N-methylmorpholine, N-cyclohexylmorpholine, 2-dimethylaminoethoxyethanol, dimethylethanolamine, tetramethylhexamethylenediamine, dimethylamino-N-methyl-ethanolamine, N-methylimidazole, N-(3-aminopropyl)imidazole, N-(3-aminopropyl)-2-methylimidazole, 1-(2-hydroxyethyl)imidazole, N-formyl-N,N′-dimethylbutylenediamine, N-dimethylaminoethylmorpholine, 3,3′-bis(dimethylamino)di-n-propylamine and/or bis(2-piperazinoisopropyl) ether, dimethylpiperazine, N,N′-bis(3-aminopropyl)ethylene-diamine and/or tris(N,N-dimethylaminopropyl)-s-hexahydrotriazine, or mixtures containing at least two of the amines mentioned. Higher molecular weight tertiary amines as described, for example, in DE-A 28 12 256 are also possible.

In a preferred embodiment, the weight ratio of c1)to c2)is from 0.005:1 to 0.5:1, preferably from 0.01:1 to 0.3:1.

In general, the component (a) is referred to as isocyanate component and the component (b) in admixture with the components (c) and, if appropriate, blowing agents and additives is referred to as polyol component.

To produce polyurethane foams, the components (a) and (b) are generally reacted in such amounts that the equivalence ratio of NCO groups to the sum of the reactive hydrogen atoms is from 1:0.8 to 1:1.25, preferably from 1:0.9 to 1:1.15. A ratio of 1:1 corresponds to an NCO index of 100.

In addition to the polyurethane foams of the invention, the invention further provides for the use of bismuth carboxylates (c1) as sole organic metal catalysts as substitutes for tin-containing catalysts in the production of polyurethanes, in particular polyurethane foams having a density of from 100 to 800 g/l.

The tin-free polyurethanes of the invention are preferably used for producing shoe soles. The invention therefore provides tin-free shoe soles comprising the polyurethane foams of the invention.

Use of bismuth carboxylates as sole organic metal catalysts as tin substitutes for producing polyurethanes, in particular microcellular, elastomeric foams, in particular for producing shoe soles, is not suggested by the prior art. On the contrary, the solutions known from the literature for producing tin-free PUR elastomers indicate that a mixture of various organic metal catalysts is necessary.

The invention is illustrated by the following examples.

### EXAMPLES

Starting Materials Used:

Polyol 1: Polyether polyol, OHN=27, nominal functionality f=3, ratio of PO/EO=77/21, EO cap
Polyol 2: Polyether polyol, OHN=29, nominal functionality f=2, ratio of PO/EO=81/19, EO cap
Polyol 3: Graft polyether polyol, OHN=27, nominal functionality f=3, about 40% acrylonitrile/styrene
CE 1: Monoethylene glycol
CE 2: 1,4-Butanediol Stabilizer: Dabco DC 193® (Air Products)
C1: Amine catalyst, Dabco DC 1® (Air Products)
C2: Amine catalyst, Lupragen N 206® (BASF)
C3: Amine catalyst, Lupragen N 202® (BASF)
C4: Tin catalyst, Niax® D22
C5: Catalyst comprising bismuth neodecanoate
ISO 510®, ISO 750/19®, ISO 500®:
   Isocyanate prepolymers from Elastogran based on 4,4′-MDI, a polyether polyol and, if appropriate, an addition of low molecular weight diols, NCO content=13.9% for ISO 510 and ISO 750/19 and 20.4% for ISO 500®
      Production of the Integral Foams:

The A and B components are intensively mixed at 23° C. in the mixing ratio described in the examples and the mixture is introduced into a plate-shaped aluminum mold which has dimensions of 20×20×1 cm and has been heated to 50° C. in such an amount that an integral foam plate having a density of 550 g/L results after foaming and curing in the closed mold.

TABLE 1
Overview of systems

| | Comp. 1 | 1 | Comp. 2 | 2 | Comp. 3 | 3 | Comp. 4 | 4 |
|---|---|---|---|---|---|---|---|---|
| Polyol component (A) | | | | | | | | |
| Polyol 1 | 27 | 27 | 37 | 37 | 45 | 45 | 52 | 52 |
| Polyol 2 | 50 | 50 | 40 | 40 | 34 | 34 | 25 | 25 |
| Polyol 3 | 10 | 10 | 10 | 10 | 10 | 10 | 10 | 10 |
| CE 1 | 8.4 | 8.4 | 8.5 | 8.5 | 7.0 | 7.0 | — | — |
| CE 2 | — | — | — | — | — | — | 9.5 | 9.5 |
| Water | 0.8 | 0.8 | 0.8 | 0.8 | 0.62 | 0.62 | 0.35 | 0.35 |
| Stabilizer | 0.2 | 0.2 | 0.2 | 0.2 | 0.2 | 0.2 | 0.40 | 0.40 |
| C1 | 3.4 | 3.4 | 3.1 | 3.1 | 2.8 | 2.8 | — | — |
| C2 | — | — | — | — | — | — | 1.41 | 1.41 |
| C3 | — | — | — | — | — | — | 0.32 | 0.32 |
| C4 | 0.03 | — | 0.03 | — | 0.02 | — | 0.02 | — |
| C5 | — | 1 | — | 0.5 | — | 0.5 | — | 0.5 |
| Isocyanate component (B) | ISO 510 | ISO 510 | ISO | ISO | ISO A | ISO A | ISO 500 | ISO 500 |
| | | | 750/19 | 750/19 | | | | |
| MR A:B = 100:x | 131 | 132 | 133 | 134 | 85 | 86 | 70 | 71 |

TABLE 2
Overview of processing properties and mechanical properties

| | Catalysis | | | | | | | |
|---|---|---|---|---|---|---|---|---|
| | Tin | Bi | Tin | Bi | Tin | Bi | Tin | Bi |
| Experiment | Comp. 1 | 1 | Comp. 2 | 2 | Comp. 3 | 3 | Comp. 4 | 4 |
| Cream time [s] | 12 | 12 | 12 | 10 | 14 | 10 | 10 | 10 |
| Buckling time [min.] | 07:30 | 05:00 | 07:00 | 03:45 | 06:00 | 04:15 | 04:15 | 04:15 |
| Dimensional change | + | + | + | + | + | + | + | + |
| Hardness [Shore A] | 55 | 53 | 52 | 53 | 55 | 57 | 51 | 50 |
| 10 min after demolding | | | | | | | | |
| Tensile strength [N/mm²] | 3.9 | 3.8 | 3.3 | 3.3 | 3.6 | 4.1 | 3.8 | 4.1 |
| Elongation at break [%] | 441 | 436 | 458 | 485 | 429 | 414 | 380 | 388 |
| Flexural fatigue test* | + | + | + | + | + | + | + | + |

*+ = crack growth after 100 kcycles < 2 mm

Table 1 summarizes the compositions of four systems (1-4) containing a catalyst according to the invention and the analogous comparative systems (Comp. 1-Comp. 4) containing tin catalysts.

Table 2 gives an overview of the processing properties and mechanical properties of the systems. The significantly shorter buckling times of the systems 1 to 4 demonstrate improved curing behavior compared to the comparative systems Comp. 1-Comp. 4. Furthermore, comparable dimensional stability after demolding is achieved. Important mechanical properties such as tensile strength, elongation or flexural fatigue properties are likewise comparable.

The measured values are determined in accordance with the following prescribed methods:

Rebound resilience in accordance with DIN 53 512, tensile strength, elongation in accordance with DIN 53 504, Shore A hardness in accordance with DIN 53 505, tear propagation resistance in accordance with DIN 53 507, flexural fatigue test in accordance with DIN 53 543.

1. A shoe sole comprising a tin-free polyurethane foam that has a density of from 100 to 800 g/l and is obtained by reacting
a) polyisocyanates with
b) compounds having isocyanate-reactive hydrogen atoms in the presence of
c1)bismuth carboxylates as catalysts, with the bismuth carboxylates being used in an amount of from 0.2 to 2% by weight, based on the total weight of the component b).

2. The shoe sole according to claim 1, wherein the bismuth carboxylates (c1) are added as sole organic metal catalysts to the reaction of the components a) and b).

3. The shoe sole according to claim 1, wherein the reaction of the components a) and b) is carried out in the presence of c1) and of c2)amines, with the weight ratio of c1)to c2)being from 0.005:1 to 0.5:1.

4. The shoe sole according to claim 1 that is an integral polyurethane foam.

5. The shoe sole according to claim 1, wherein the bismuth carboxylates (c1) result from carboxylic acids having from 6 to 12 carbon atoms.

6. A process for producing shoe soles comprising tin-free polyurethane foams that have a density of from 200 to 800 g/l, the process comprising reacting
a) polyisocyanates with
b) compounds having isocyanate-reactive hydrogen atoms in the presence of
c1)bismuth carboxylates as catalysts, with the bismuth carboxylates being used in an amount of from 0.2 to 2% by weight, based on the total weight of the component b).

7. In a process for the production of polyurethane foams using organic metal catalysts, the improvement comprising using bismuth carboxylates as the sole organic metal catalysts.

8. (canceled)

9. The shoe sole according to claim 4 that is a flexible integral polyurethane foam.
